(19) United States
(12) Patent Application Publication
(10) Pub. No.: US 2005/0235080 A1
(43) Pub. Date: Oct. 20, 2005

(54) Speed matching data storage system

(76) Inventor: Mohamad El-Batal, Westminster, CO (US)

Correspondence Address: LSI LOGIC CORPORATION, 1621 BARBER LANE, MS: D-106, MILPITAS, CA, 95035, US

(21) Appl. No.: 10/826,009

(22) Filed: Apr. 16, 2004

(51) Int. Cl. G06F 13/38

(52) U.S. Cl. 710/74

(57) ABSTRACT

A system and method for storing data wherein an incoming data stream is buffered and split into two or more slower data streams that are switched to two or more data storage devices. A controller, such as a RAID controller, may send stripes of data that are broken into data strips that are written to individual disk drives. The data strips enter a FIFO buffer at a first speed, which creates two or more nearly simultaneous data streams at a second, slower speed, each data stream containing specific strips destined for specific disk drives. The data streams are then switched to the specific disk drives for writing onto the storage media. Embodiments may be adapted for both the storage and retrieval of data.

### Background of the Invention

1. Field of the Invention

The present invention pertains generally to data storage systems and specifically to high speed data throughput systems used to communicate with a plurality of storage devices.

2. Description of the Background

Multiple disk based storage systems, such as (Redundant Array of Independent Disks) RAID and other systems may be configured to send and receive data in ever increasing data rates. As a higher speed data transfer rates become available, disk drive components for disk-based storage systems capable of communicating at these faster rates are typically among the last components to appear in the marketplace.

The throughput or communication speed of a disk based storage system is one of the most critical performance metrics of the system. In general, the higher the communication speed, the more data that can be transferred and the more requests that can be serviced. If a disk based storage system has a low communication speed, it can service a limited number of requests and may be a bottleneck in a specific computer architecture.

Disk drives that are capable of communicating on the fastest available data throughput are generally more expensive than those disk drives with slower data throughput. Disk based storage systems that may offer a certain data throughput but use lower cost disk drives may have a cost advantage.

It would therefore be advantageous to provide a system and method whereby a data storage system communicates using a throughput that is higher than the maximum throughput of the disk drives contained in the storage system. It would be further advantageous if such a system performed at an equivalent performance as if the disk drives were capable of the data throughput of the entire system.

### SUMMARY OF THE INVENTION

The present invention overcomes the disadvantages and limitations of previous solutions by providing a system and method for storing data wherein an incoming data stream is buffered and split into two or more slower data streams that are switched to two or more data storage devices. A controller may send stripes of data that are separated into data strips that are written to individual disk drives. The data strips enter a FIFO buffer at a first speed, which creates two or more data streams at a second speed, each data stream containing specific strips destined for specific disk drives. The data streams are then switched to the specific disk drives for writing onto the storage media.

An embodiment of the present invention may include a method for storing data on a plurality of disk drives comprising: addressing a plurality of data strips from the data to a chosen disk of the plurality of disk drives; forming a data stream comprising the data strips, the data stream having a first throughput; creating a plurality of parallel data streams, each of the plurality of parallel data streams having a second throughput, the second throughput being smaller than the first throughput; directing the plurality of parallel data streams to a corresponding plurality of the plurality of disk drives such that each data strip in the plurality of data strips is transmitted to the chosen disk of the plurality of disk drives; and storing each of the data strips on the each of plurality of disk drives.

Another embodiment of the present invention may include a system for storing data comprising: a plurality of disk drives each having a communication channel capable of communicating at a first throughput; a controller adapted to address a plurality of data strips from the data to a chosen disk of the plurality of disk drives, and form a data stream comprising the data strips, the data stream having a second throughput; a buffered switch in communication with the controller and adapted to create a plurality of parallel data streams, each of the plurality of parallel data streams having a second throughput, the first throughput being smaller than the second throughput; a crossbar switch in communication with the buffered switch and adapted to direct the plurality of parallel data streams to a corresponding plurality of the plurality of disk drives such that each of the separate data strips are transmitted to each of the plurality of disk drives to which the separate data strips are addressed; and wherein the plurality of disk drives are adapted to receive the plurality of parallel data streams and store the data strips on the disk drives.

Yet another embodiment of the present invention may include a system for storing data comprising: a plurality of storage means each having a communication channel capable of communicating at a first throughput; a controlling means adapted to determine a first data stripe to store onto the plurality of disk drives, the data stripe containing a separate data strip addressed to each of the plurality of disk drives, and adapted to provide a first data stream having a second throughput and containing the data strips; a buffer means in communication with the controlling means and adapted to receive the first data stream, the buffer means having a first-in-first-out buffer into which the first data stream is received at the second throughput, the buffer means further adapted to remove the data strips from the first-in-first-out buffer to create a plurality of parallel data streams, each of the plurality of parallel data streams having the first throughput, the first throughput being smaller than the first throughput; a switch means in communication with the buffer means and adapted to direct the plurality of parallel data streams to a corresponding plurality of the plurality of disk drives such that each of the separate data strips are transmitted to each of the plurality of disk drives to which the separate data strips are addressed; and wherein the storage means are adapted to receive the plurality of data streams and store the data strips on the storage means.

The advantages of the present invention are that a storage system with a very high data throughput may be constructed of disk drives with a lower throughput. Additionally, a disk based storage system may contain lower cost disk drives to achieve the same performance standards of other storage systems.

### BRIEF DESCRIPTION OF THE DRAWINGS

In the drawings,

FIG. 1 is an illustration of an embodiment of the present invention showing a high speed RAID data storage system.

FIG. 2 is an illustration of an embodiment of the present invention showing a flow chart embodiment of a method for storing data.

FIG. 3 is an illustration of an embodiment of the present invention showing a RAID data storage system.

### DETAILED DESCRIPTION OF THE INVENTION

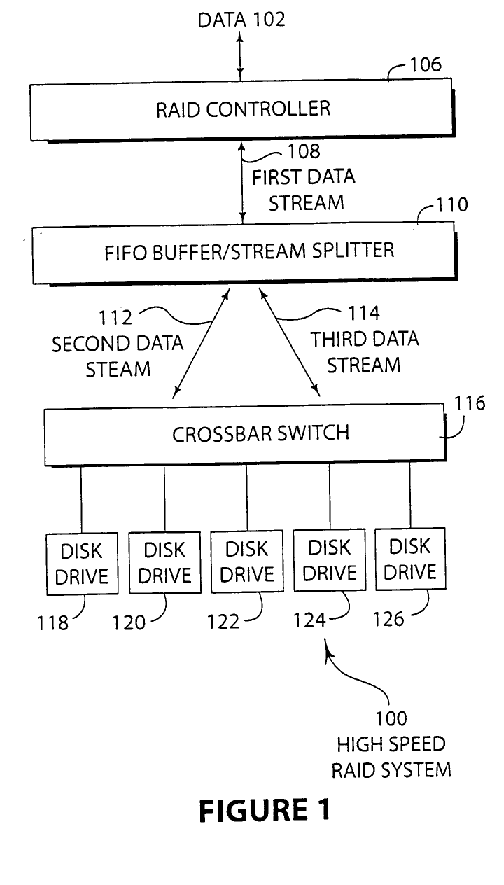

FIG. 1 illustrates an embodiment 100 of the present invention showing a high speed RAID data storage system. Data 102 is transmitted and received by a RAID controller 106. The RAID controller 106 transmits and receives data from the disk drives through a first data stream 108 to/from a FIFO buffer and stream splitter 110. The FIFO buffer and stream splitter 110 creates a second data stream 112 and a third data stream 114 that are simultaneously transmitted to a crossbar switch 116 that switches the appropriate incoming data streams 112 and 114 to one of the disk drives 118, 120, 122, 124, or 126. In some embodiments, the FIFO buffer and stream splitter 110 and the crossbar switch 116 may be combined into a dynamic buffering crossbar switch.

One performance metric of the overall system is the amount of data 102 that can be continuously transmitted and received. In the embodiment 100, the data throughput or transmission speed of the first data stream 108 may be about twice that of the second data stream 112 and third data stream 114.

The RAID controller 106 receives data storage and retrieval requests from other systems. In an example of receiving a data storage request, the RAID controller that is operating as a RAID 5 controller will transform the incoming data into stripes of data that are to be written to the various disks. In so doing, the RAID controller 106 will create strips of data, each strip being addressed for a specific disk drive 118-126. In some embodiments, one or more of the strips may contain parity data. The RAID controller 106 may transmit the strips of data to the FIFO buffer and stream splitter 110.

The FIFO buffer and stream splitter 110 may be capable of receiving a first data stream 108 that contains packetized data for that make up two or more separate data streams, such as data streams 112 and 114. The splitter 110 may receive data into a first in, first out (FIFO) buffer, and then take out the various packets to create two or more simultaneous data streams. The two or more simultaneous data streams may be operated at slower speeds than the incoming data stream. For an example of two simultaneous outgoing data streams, each of the outgoing data streams may be approximately half of the data throughput of the incoming data stream. In an example of three simultaneous outgoing data streams, each of the outgoing data streams may be approximately one third of the data throughput of the incoming data stream.

The outgoing data streams 112 and 114 may contain specific strips of data that are intended for specific disk drives 118-126. Each of the data streams 112 and 114 may be switched to the specific disk drive 118-126 through the crossbar switch 116.

The crossbar switch 116 may be capable of switching two or more input streams to two or more output devices simultaneously. The switch 116 may interpret an address in a data stream and switch the data stream to communicate with a specific device. In the embodiment 100, the crossbar switch 116 may have two input streams 112 and 114 and may connect either input stream to any of the disk drives 118-126.

Because the data streams 112 and 114 may be selected to be the maximum data transfer rate or throughput of the disk drives 118-126, the embodiment 100 may have an overall data throughput of approximately twice that of the individual disk drives 118-126. For example, if the disk drives 118-126 were capable of 2 Gb/s transfer rate, the data streams 112 and 114 may operate at 2 Gb/s and the first data stream 108 and incoming data 102 may transfer data at 4 Gb/s.

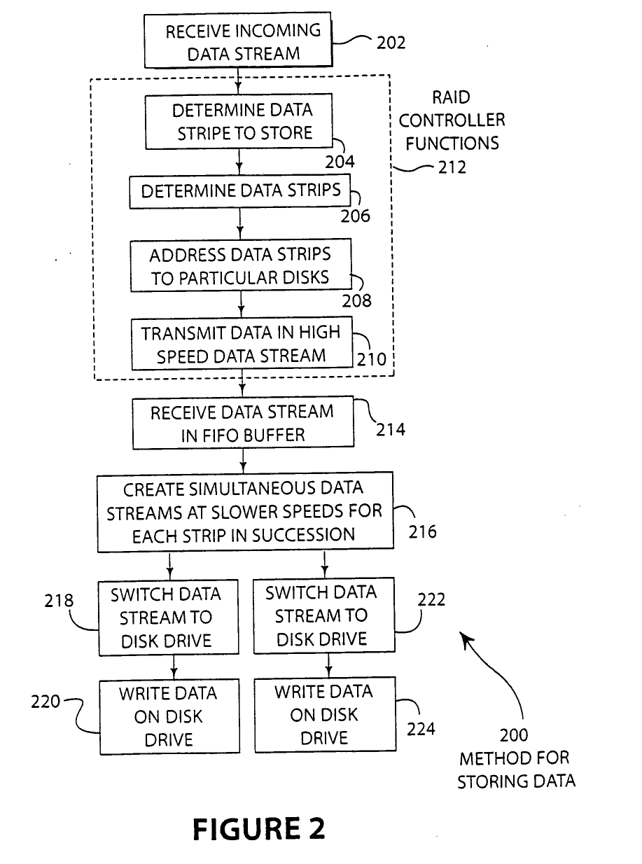

FIG. 2 illustrates a flow chart embodiment 200 of the present invention showing a method for storing data. The data is received in block 202. The data is converted into a stripe of data in block 204, which is in turn converted into strips in block 206. Each strip of data is assigned an address to a particular disk is block 208 and the strips are converted into a high speed data stream in block 210. The operations of blocks 204-210 are functions that may be performed by a RAID controller as shown by block 212.

The high speed data stream is received in a FIFO buffer in block 214. Data is taken out of the FIFO buffer to create simultaneous data streams at slower speeds for each strip in block 216. The first data stream is switched to a disk drive in block 218 and written to a disk drive in block 220. Similarly, a second data stream is switched to another disk drive in block 222 and written to the second disk drive in block 224.

A stripe of data, such as in block 204, may contain a block of data that is sent to several disk drives, such as in a RAID or similar multiple-disk storage system. Each stripe of data contains a strip of data that is written to a particular disk drive. One or more of the strips of data may contain parity or other type of redundant data storage. In some embodiments, such as a RAID 1 embodiment, no parity or other transformation of the data is performed.

In the present embodiment, the strips of data are prepared and transmitted on a high speed data stream in block 210 to the FIFO buffer in block 214. The functions of the RAID controller in block 212 may be typical controller functions for a multiple disk drive data storage system. The outgoing data stream is split into two simultaneous data streams at potentially slower data rates in block 216 and each data stream is written to disks substantially simultaneously.

Those skilled in the art will appreciate that the method illustrated in FIG. 2 may be used for the retrieval of data from disk drives when the method is operated in reverse.

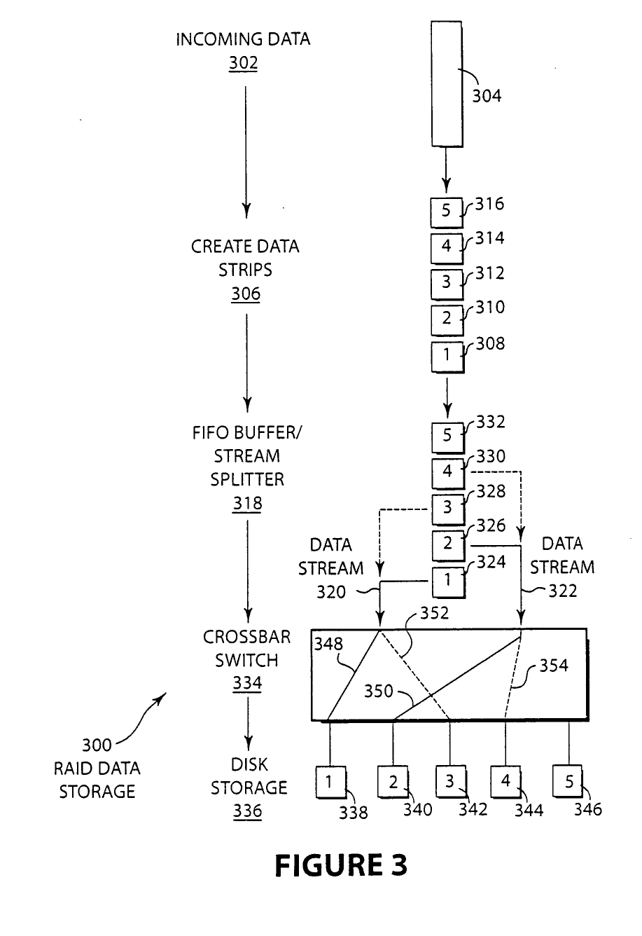

FIG. 3 illustrates an embodiment 300 of the present invention showing a RAID data storage system. The incoming data 302 may be illustrated as a block of data 304. Data strips are created 306 as shown by data strips 308-316. The FIFO buffer/stream splitter 318 may be illustrated by the data blocks 324-332. Data strip 324 may be pulled from the FIFO buffer and transmitted in data stream 320. Similarly, data strip 326 may be pulled from the FIFO buffer and transmitted in data stream 322. Data strip 328 may be removed from the FIFO buffer and transmitted in data stream 320. Likewise, data strip 330 may be pulled from the FIFO buffer and transmitted in data stream 322.

The crossbar switch 334 connects to the disk storage devices 338-346. When data strip 324 enters data stream 320, the crossbar switch 334 connects data stream 320 to disk drive 338 using connection 348. As data strip 326 enters data stream 322, the crossbar switch 334 connects data stream 322 to disk drive 340 using connection 350. When data strip 328 enters data stream 320, the crossbar switch connects to disk drive 342 through connection 352. Similarly, when data strip 330 enters data stream 322, crossbar switch 334 connects data stream 322 to disk drive 344 using connection 354.

The FIFO buffer/stream splitter 318 may transmit data simultaneously on data streams 320 and 322 at a specific data transfer rate, while receiving data at approximately the sum of the data transfer rates of data streams 320 and 322. In a typical multiple disk storage system, the data transfer rates of data streams 320 and 322 will be approximately the same. In other embodiments, the FIFO buffer/stream splitter 318 may have three or more output streams, depending on the buffer design. In such cases, three or more output streams may be capable of simultaneously transferring data and the overall data transfer rate of the system will be approximately the sum of all of the outgoing data streams.

In the forgoing description, embodiments of the invention were illustrated by describing the writing process of a multiple disk storage system. Those skilled in the art will appreciate that the structure and methods of the embodiment may be equally adapted to reading data from a multiple disk storage system while keeping within the spirit and intent of the present invention. The benefits of the invention can be appreciated in both the storage and retrieval of data.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for storing data on a plurality of disk drives comprising:
addressing a plurality of data strips from said data to a chosen disk of said plurality of disk drives;
forming a data stream comprising said data strips, said data stream having a first throughput;
creating a plurality of parallel data streams, each of said plurality of parallel data streams having a second throughput, said second throughput being smaller than said first throughput;
directing said plurality of parallel data streams to a corresponding plurality of said plurality of disk drives such that each data strip in said plurality of data strips is transmitted to said chosen disk of said plurality of disk drives; and
storing each of said data strips on said each of plurality of disk drives.

2. The method of claim 1 wherein the number of said plurality of parallel data streams is approximately equal to said first throughput divided by said second throughput.

3. The method of claim 2 wherein said number of said plurality of parallel data streams is 2.

4. The method of claim 2 wherein said number of said plurality of parallel data streams is 4.

5. The method of claim 1 wherein at least one of said data strips comprises parity information.

6. The method of claim 1 wherein said creating a plurality of parallel data streams is performed by a first-in-first-out buffer.

7. The method of claim 1 wherein said directing said plurality of parallel data streams is performed by a crossbar switch.

8. The method of claim 1 further comprising:
reading said each of said data strips from said plurality of disk drives;
transmitting said each of said data strips from said plurality of disk drives in said plurality of parallel data streams; and
transmitting said first data stream containing said data strips.

9. A system for storing data comprising:
a plurality of disk drives each having a communication channel capable of communicating at a first throughput;
a controller adapted to address a plurality of data strips from said data to a chosen disk of said plurality of disk drives, and form a data stream comprising said data strips, said data stream having a second throughput;
a buffered switch in communication with said controller and adapted to create a plurality of parallel data streams, each of said plurality of parallel data streams having a second throughput, said first throughput being smaller than said second throughput;
a crossbar switch in communication with said buffered switch and adapted to direct said plurality of parallel data streams to a corresponding plurality of said plurality of disk drives such that each of said separate data strips are transmitted to each of said plurality of disk drives to which said separate data strips are addressed; and
wherein said plurality of disk drives are adapted to receive said plurality of parallel data streams and store said data strips on said disk drives.

10. The system of claim 9 wherein the number of said plurality of parallel data streams is approximately equal to said second throughput divided by said first throughput.

11. The system of claim 10 wherein said number of said plurality of parallel data streams is 2.

12. The system of claim 10 wherein said number of said plurality of parallel data streams is 4.

13. The system of claim 9 wherein at least one of said data strips comprises parity information.

14. A system for storing data comprising:
a plurality of storage means each having a communication channel capable of communicating at a first throughput;
a controlling means adapted to determine a first data stripe to store onto said plurality of disk drives, said data stripe containing a separate data strip addressed to each of said plurality of disk drives, and adapted to provide a first data stream having a second throughput and containing said data strips;
a buffer means in communication with said controlling means and adapted to receive said first data stream, said buffer means having a first-in-first-out buffer into which said first data stream is received at said second throughput, said buffer means further adapted to remove said data strips from said first-in-first-out buffer to create a plurality of parallel data streams, each of said plurality of parallel data streams having said first throughput, said first throughput being smaller than said first throughput;
a switch means in communication with said buffer means and adapted to direct said plurality of parallel data streams to a corresponding plurality of said plurality of disk drives such that each of said separate data strips are transmitted to each of said plurality of disk drives to which said separate data strips are addressed; and
wherein said storage means are adapted to receive said plurality of data streams and store said data strips on said storage means.

15. The system of claim 14 wherein the number of said plurality of parallel data streams is approximately equal to said second throughput divided by said first throughput.

16. The system of claim 15 wherein said number of said plurality of parallel data streams is 2.

17. The system of claim 15 wherein said number of said plurality of parallel data streams is 4.

18. The system of claim 14 wherein at least one of said data strips comprises parity information.
